(19) United States
(12) Patent Application Publication
(10) Pub. No.: US 2014/0090190 A1
(43) Pub. Date: Apr. 3, 2014

(54) Ramp System

(71) Applicant: Joanna D. McCloskey, Huntington, NY (US)

(72) Inventor: Joanna D. McCloskey, Huntington, NY (US)

(21) Appl. No.: 13/632,940

(22) Filed: Oct. 1, 2012

(51) Int. Cl. B65G 69/28

(52) U.S. Cl. 14/69.5

(57) ABSTRACT

A ramp system comprising: a platform, a box beam connecting a pair of stringer sides, wherein the stringer sides are connected to the box beam; the stringer sides having an upper and lower surface, wherein the lower surface is designed to contact the ground and the upper surface forming a rail; the box beam having a lower surface designed to contact the ground, and the upper surface to be less in height than the upper surface of the stringer sides; the lower surface of the platform is connected to the upper surface of the box beam, and stringer sides such that the distal end is flush with the outer portion of the box beam, and the proximal end is flush with the pointed end of the stringer sides, and the two sides of the platform abut the inner surface of the stringer sides forming a ramp with guard rails.

### CROSS REFERENCE TO RELATED APPLICATIONS

This application claims priority from U.S. patent application Ser. No. having Ser. No. 61/541,075 having a filing date of 29 Sep. 2011.

### BACKGROUND OF THE INVENTION

This invention relates to a ramp system, in particular, a ramp system that provides, inter alia, a light weight portable ramp system for use with horticultural carts.

Historically, operators, whether employers or employees who had the need to relocate populated horticultural carts from two different levels of ground, such as between a parking lot, and the sidewalk, would need to either spend the time to push/pull the populated heavy cart to an apron/cutout in the curb, or, if strong enough, picking up the lead end, whilst standing on the curb, or popping a wheelie from the lower level to get the lead end onto the curb, wherein in these non-apron approaches, the operator runs the risk of personal injury and/or property damage, such as a back injury, wrist injury from pushing/pulling, and/or property damage if the rack/cart tips over itself, and/or if the plants fall off the shelving onto the operator and/or floor/ground. Moreover, the integrity of the cart might be compromised by these non-apron activities, increasing the risk of further personal injury and/or property damage sometime in the future, and shortening the life span of the cart, wherein all these scenarios there is an increase in the costs of doing business, hence there is a compelling need for an ergonomic, light weight, portable ramp system for use with horticultural carts.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates a front view of the preferred embodiment;

FIG. 2 illustrates a top view of the preferred embodiment;

FIG. 2A illustrates a right side view of the preferred embodiment;

FIG. 2B illustrates the dimensions of the box beam of the preferred embodiment;

FIG. 2C illustrates support structure and the dimensions thereof, of the preferred embodiment;

FIG. 3 illustrates the front view of the box beam with a relief pattern;

FIG. 3A illustrates a side view of FIG. 3;

FIG. 3B illustrates a top view of an inner platform joist of the preferred embodiment;

FIG. 3C illustrates a side view of FIG. 3B;

FIG. 3D illustrates an end view of FIG. 3C;

FIG. 4 illustrates an alternative embodiment, having different relief patterns.

### DETAILED DESCRIPTION OF THE INVENTION

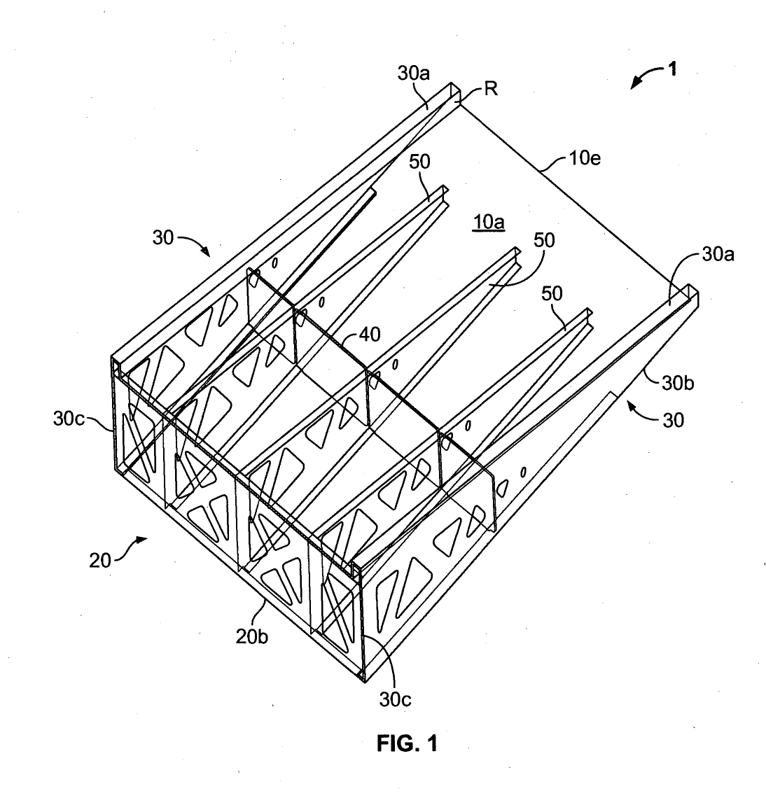

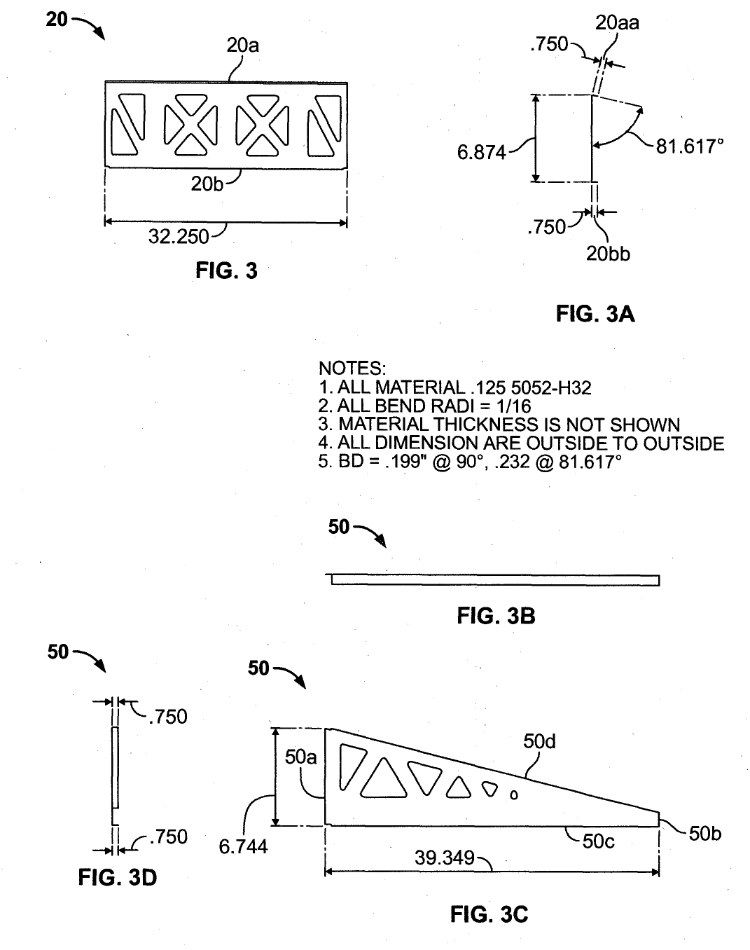

The following description of the preferred embodiments are presented to illustrate the present invention and are not to be construed to limit the claims in any manner whatsoever. In reference to the drawings, namely, FIGS. 1 to 4, the preferred embodiment of the present invention is disclosed, which is directed to a lightweight portable ramp system 1.

In a preferred embodiment, the ramp system 1 includes a platform 10 having an upper and lower surface 10a, 10b, two sides 10c, 10d, and a proximal and distal end 10e, 10f, wherein the platform further has a thickness, a length and width.

The system 1 further includes a box beam 20 having a height, a width, a thickness, and connects a pair of stringer sides 30. The beam has a flange 20aa, 20bb on both the upper and lower surface 20a, 20b, wherein the flange 20aa is bent to the desired angle, here to about 81.617 degrees, and the flange 20bb is perpendicular to the beam and extends about 0.750 inches; wherein the height is about 5.874 inches.

The stringer sides 30 have a variable height, width, and length, with a flange, but are triangular and the tall ends 30c of the stringer sides 30 are connected to the box beam 20; the stringer sides 30 having an upper and lower surface 30a,30b, wherein the lower surface 30b via flange 30bb, is designed to contact the ground and the upper surface 30a forming a rail R having an overall height of about 8.008 inches and a Rail to platform height of about 1.133 inches. The box beam 20 having an upper and lower surface 20a,20b wherein the lower surface 20b is designed to contact the ground via flange 20bb, and the upper surface 20a to be less in height than the upper surface 30a of the stringer sides 30 and is designed to support the underside 10b of platform 10 via flange 20aa.

The lower surface 10b of the platform 10 is connected to the upper surface 20a of the box beam 20, and stringer sides 30 such that the distal end 10f is flush with the outer portion of the box beam 20, and the proximal end 10e is flush with the pointed end 30d of the stringer sides 30, and the two sides 10c, 10d of the platform 10 abut the inner surface 30e of the stringer sides 30 forming a ramp with guard rails.

The ramp system 1, further comprising a support structure 40 having a height, width, and thickness, and is positioned between the box beam 20 and the proximal end of the platform 10e, connected to the inner sides of the stringer sides 30e, and having a height that contacts the ground and the lower surface of the platform 10b, wherein the height is about 4.138 inches.

The ramp system 1, further comprising a inner platform joist 50 having an upper and lower surface 50a,50b the same slope M as the stringers upper surface 30c, and having a first end 50c having a common height as the box beam 20 and being connected thereto, and positioned between the stringer sides 30, and a second end 50d that approaches the proximal end 10e, wherein the bottom of the platform joist 50b is less than the bottom of the stringer sides 30b, and is parallel to the stringer sides 30.

The ramp system 1 further comprising a plurality of inner platform joists 50.

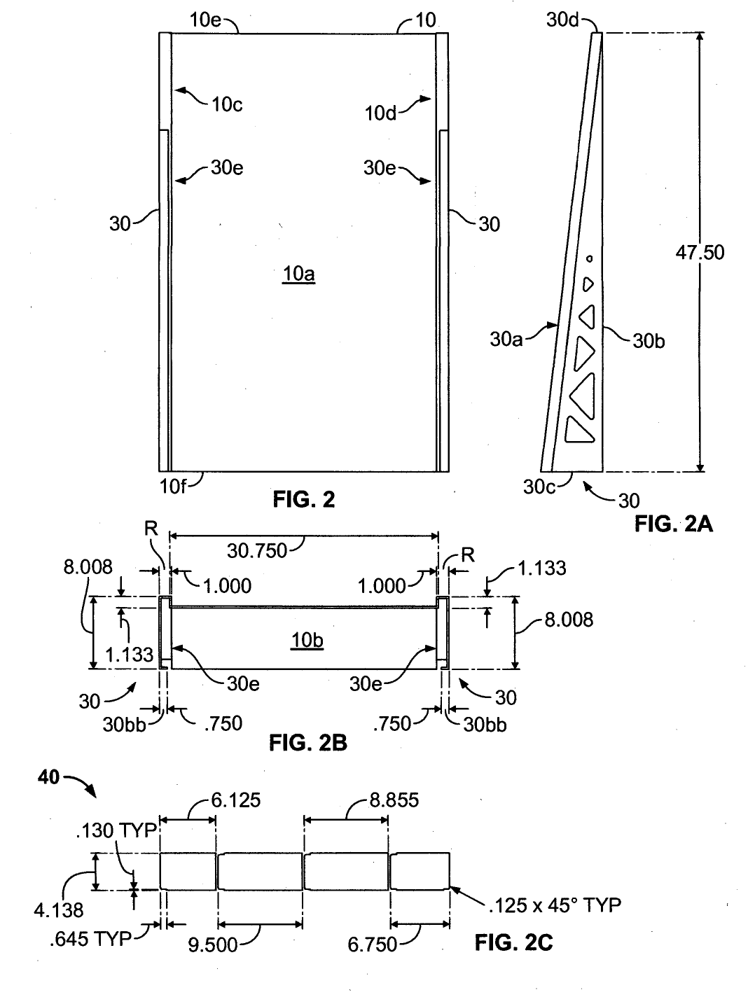

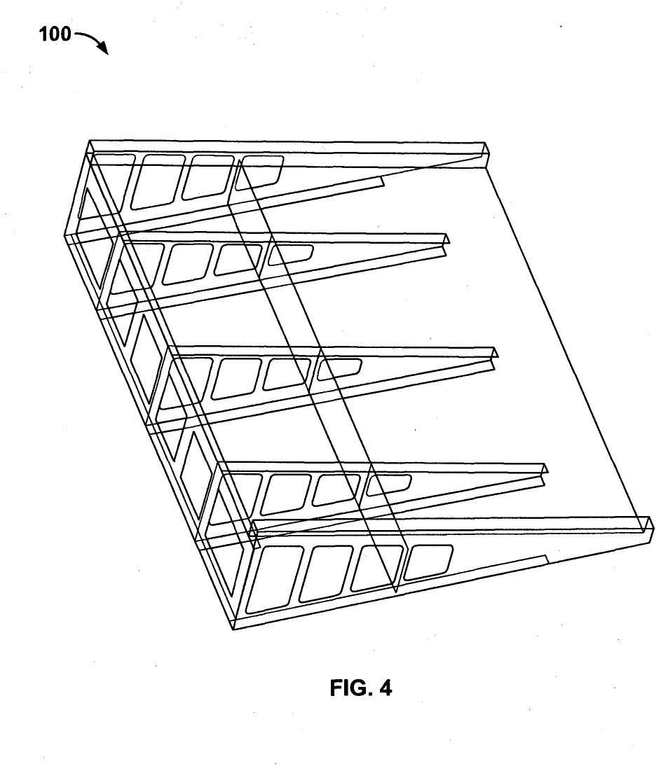

The ramp 1 is made from a material that is light weight, with high resistance to oxidation, such as Aluminum 5052-H32, in the preferred embodiment the material thickness is 0.125 inches. In order to further reduce the weight of the ramp 1, relief patterns are used in the box beam 20, the stringers 30, and the inner platform joists 50, wherein this embodiment, triangular patterns have been incorporated, it is envisioned alternative shapes may be incorporated for aesthetic reasons as well, such as rectangles, or other polygonal shapes, as illustrated in FIG. 4. The material is cut to shape, and bent to desired dimensions having a bend radius; here a bend radius of one-sixteenth of inch was utilized. It is envisioned that placement of the inner joists 50 may be equidistant, as illustrated in FIG. 2C which illustrates the spacing of the joists 50 as per the support structure 40. The alignment of the pieces, namely, the platform 10, the beam 20, the stringers 30, the support structure 40, the joist(s), 50 include interlocking features based on the flanges, and are held together by conventional methods, including, welding.

In use the operator will place the ramp between the two difference surfaces thereby bridging the two surfaces to enable an operator to move a horticultural cart from one surface to the other quite readily. The ramp optionally includes a slip reducing feature on the upper surface 10a to increase safety by reducing risk of slip and falling by the operator. This feature includes applying self-adhesive grip tape, or spraying on a non-slip or slip reducing coating on at least a portion of the surface 10a.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. A ramp system comprising:
a platform having an upper and lower surface, two sides, and a proximal and distal end;
a box beam connecting a pair of stringer sides, wherein the stringer sides are triangular and the tall ends of the stringer sides are connected to the box beam; the stringer sides having an upper and lower surface, wherein the lower surface is designed to contact the ground and the upper surface forming a rail;
the box beam having an upper and lower surface wherein the lower surface is designed to contact the ground, and the upper surface to be less in height than the upper surface of the stringer sides; wherein said beam having an outer portion facing outwardly from said system, and an inner portion facing inwardly toward said system;
the lower surface of the platform is connected to the upper surface of the box beam, and stringer sides such that the distal end is flush with the outer portion of the box beam, and the proximal end is flush with the pointed end of the stringer sides, and the two sides of the platform abut the inner surface of the stringer sides forming a ramp with guard rails.

2. A ramp system as in claim 1, further comprising a support structure positioned between the box beam and the proximal end of the platform, connected to the inner sides of the stringer sides, and having a height that contacts the ground and the lower surface of the platform.

3. A ramp system as in claim 1, further comprising an inner platform joist having the same slope as the stringers upper surface, having a first end having a common height as the box beam and being connected thereto, and positioned between the stringer sides, and a second end that approaches the proximal end, wherein the bottom of the platform joist is less than the bottom of the stringer sides, and is parallel to the stringer sides.

4. A ramp system as in claim 1, further comprising a plurality of inner platform joists.

5. A ramp system as in claim 1, wherein the box beam has a relief.

6. A ramp system as in claim 1, wherein the stringers have a relief.

7. A ramp system as in claim 3, wherein the inner joist has a relief.

8. A ramp system as in claim 1, wherein at least two of the pieces are interlocking.

9. A ramp system as in claim 8, wherein the interlocking features include flanges.
